(19) United States
(12) Patent Application Publication
(10) Pub. No.: US 2007/0050070 A1
(43) Pub. Date: Mar. 1, 2007

(54) AUTOMATED BATCH MANUFACTUIRNG

(75) Inventors: Cathal Strain, Fairfield, CT (US); Adam Lalonde, Quaker Hill, CT (US); Richard Kimball, Colchester, CT (US); Majdi Rajab, Houston, TX (US)

Correspondence Address: PFIZER INC, 150 EAST 42ND STREET, 5TH FLOOR - STOP 49, NEW YORK, NY, 10017-5612, US

(73) Assignee: Pfizer Inc

(21) Appl. No.: 11/462,194

(22) Filed: Aug. 3, 2006

Related U.S. Application Data
(60) Provisional application No. 60/705,972, filed on Aug. 5, 2005.

(51) Int. Cl. G06F 19/00

(52) U.S. Cl. 700/99; 700/97

(57) ABSTRACT

An integrated automated management system for batch manufacturing of products, particularly pharmaceuticals. The system comprises: a distributed data with process related information, a design module which extracts information to build operating models for the manufacturing; a planning module which interacts with the data base and design module to provide the financial and scheduling aspects of the manufacturing, and an exploring module, interfaced with the data base and the other modules, in a closed operational loop to provide real time analysis of the operating model in comparison to actual manufacture to provide real time quality control

### TECHNICAL FIELD

The invention relates to an automated manufacturing management system for industries such as pharmaceutical, chemical, food & beverage, cosmetics and other process manufacturing and to discrete manufacturing industries such as electronics and vehicles and particularly relates to batch manufacturing design, planning and quality control, particularly for the production of pharmaceuticals.

### BACKGROUND OF THE INVENTION

The most widely adapted standards for manufacturing control systems in the US and Europe are ISA S88.01 and IEC 61512-01 respectively (the disclosures of which are incorporated herein by reference thereto as being widely known in the art). These standards refer to various models such as equipment models and recipe models and the various modules and components involved in manufacturing and batch control. Terminology and methodology used hereinafter are specifically with respect to those defined in such standards and particularly in ISA S88.01 (S88).

Many of the actual processes in batch manufacturing of products such as chemicals, particularly pharmaceuticals and biologicals are run and controlled, in accordance with the S88 standards, using automated computer driven programs. However, the actual design, planning and feedback-quality control have extensive manual components and manual data entries, albeit with the use of computer systems.

Manufacturing plants at pharmaceutical companies and in many other industries are often run on a 24/7 basis and appropriate process design and scheduling of manufacture is an economic necessity but one in which use of conventional computer tools (for example spread sheets) is labor intensive and not well integrated to execution systems. Consequently, the manual entries or calculated results from one production system must be carefully transcribed and constantly verified to ensure that values have not changed at different stages or systems of the process.

Chemical and particularly pharmaceutical production involves the scaling up from laboratory discovery and synthesis to large scale commercial production and batch processes. Batch manufacture of other products and commodities involves analogous scale up and processes. Common steps to achieve this scale-up include the steps of designing a process model (the sequence of steps involved in the manufacturing process) then a plant model (an identification of available equipment at a plant site with capabilities as necessary for effecting the manufacturing steps with correlation thereto) and finally a control model with control parameters and instructions, i.e., operational parameters on the plant model. In this latter stage, recipe configuration data is generated and correlated with electronic work instructions and/or process control systems for material tracking and automated or manual recipe execution. There is an interface to analyze system performance with raw data generation of events, alarms, and user actions all with time stamps. Also collected are process analytical technology (PAT) and conventional instrument data with the generation of reports and process notes as well as the triggering of investigations of events (as needed). As referred to above, production requires scheduling to encompass facilitated manufacture of different products using common equipment as well as to allow factoring in of availability of raw materials and other resources.

A final and very important part of manufacturing procedure is that of production data analysis feedback and quality control. Factors involved in this step include shift management (particularly germane to 24/7 production lines), performance management and optimization, batch review and cross batch analysis and evaluation of process capability. Overriding concerns include inventory control and management, financial considerations and planning and an overall picture of the supply chain.

In a typical pharmaceutical production timeline in the United States a new product application (NDA) is submitted to the FDA (or equivalent regulatory authority in other countries or regions) together with a production process with basic parameters usually developed in the research lab. The process is then further developed for improvement in terms of yield, purity, economics, raw product availability; etc. Once the process is developed, it is scaled up with equipment needs being defined as well as processing steps and materials involved. Planning and scheduling is then calculated relative to a plant schedule of other product production. Operating instructions are prepared in a pre-campaign set-up and a recipe is formulated for a production execution system which may comprise a DCS (distributed control system), or an Electronic Work Instruction, or other processor, or any combination of these computer based execution systems. A solvent or water run or dry run (if required), or other offline production simulation run is then effected to fine tune the system and the campaign (which defines a sequence of one or more batches) is run. Batches of product (active pharmaceutical product or API) are released, with notation of deviations, changes and review. Deviations are investigated as to source and, with clearance, drug product manufacturing, with the API, begins. Similar design, planning and execution processes are then carried out in drug product manufacturing. In order to maintain quality, efficiency and safety standards and to effect improvements there is a constant monitoring and analysis of all the manufacturing information.

While many of the above steps are currently carried out with computerized tools such as spread sheets, and specialized manufacturing software control products, there remain many manual data entry points and manipulation which may lead to costly transcription errors. To avoid such occurrences, quality control with respect to the manual entry must be an ongoing process. While laudable, this increases overall costs and results in lost manufacturing time. In addition, quality control is applied on a time lag basis, after batches have been produced and problems have been discovered and investigated. With pharmaceuticals this can be up to several weeks and in other industries there is a quality control delay of at least several days, and often longer, as a general production occurrence. Thus, if there is a quality control problem, batches already produced may have to be discarded.

### SUMMARY OF THE INVENTION

It is an object of the present invention to provide an overall integrated totally computerized automated process and system encompassing the entire manufacturing procedure from design and planning through production and feedback refinement, especially when the production is performed on a batch basis as part of an overall multi-product manufacturing regime.

It is a further object of the present invention to provide the overall system with a single input of any given data for the entire manufacturing process from design through manufacture to avoid transcription errors.

It is yet another object of the present invention to provide a system with capability of correlating process design data with physical equipment and material attributes and detailed equipment operating steps to intelligently create detailed design data, schedules, and operating documents.

It is another object of the present invention to provide a comparison between a planned manufacturing model and actual manufacture, to observe and assess deviations therebetween with optional controlled changes in the model.

Another object of the present invention is to provide an automated system with sufficient control to maintain batch consistency and to improve yields, as well as to improve quality control and process efficiency.

In another objective, real-time analysis of the manufacturing process is available at any time, with rich graphical information generation display.

Another objective is to provide an automated system that evaluates, in real-time, actual production status and presents it against planned production, and then re-projects estimated times for future operating steps, thereby providing plant operating personnel with rich, accurate near term planning information.

It is another object of the present invention to provide a system with full input knowledge of all product synthesis requirements, available equipment capability and production information of all products being manufactured at a site or other linked site, whereby product production scheduling, with equipment and machinery capability, availability and maintenance, inventory and requirements, etc. are available and are constantly updated for maximum efficiency and product quality with tightly maintained parameters.

Another object is to maintain high level requirements (e.g., FDA mandated requirements) control, without deviation at any stage of design, production and feedback.

Still another object of the present invention is a system which provides a real time quality control during production with feed back to permit the immediate taking of corrective measures either automatically or manually.

Generally the present invention comprises an integrated automated management system for batch manufacturing of products. The system comprises a distributed data base having stored parameters and details of processed materials and components, and equipment used for the manufacturing of products in which at least some of the equipment is common in the production of multiple products. The database contains process models, production schedules and respective use of equipment and shared equipment. The data base further comprises means for storage of details of actual production and correlation to financial, quality and performance criteria. The system further comprises:

i. a design module for the design of the batch manufacturing process, the design module being adapted to correlate input process sequence details of operating process with appropriate stored parameters and details extracted from the distributed data base to build process controlling operating spread sheets with operation steps and allocated and shared equipment, where applicable,

ii. a planning module which interacts with the design module and the database to create production schedules accounting for equipment overlap use and cost factors and subsequently updating, the design modules to establish final projection of time and materials based on the equipment, and

iii. an exploring module which is interfaced with the data base and with the design and planning modules in a closed quality control loop with the system comprising means to keep a real time tracking of materials, production requirements, equipment sharing and maintenance along with operating steps and production data, with automated means to modify times projected for future manufacturing steps and equipment use according to real time events affecting operation, equipment and cost factors.

The above and other objects, features and advantages of the present invention will become more evident from the following discussion and drawings in which:

### SHORT DESCRIPTION OF THE DRAWINGS

FIG. 1 is an interface depiction of the components of the modules of the system of the present invention and their interaction with each other and the production system;

FIGS. 1A-1G are expanded views of segments of FIG. 1 as indicated, for clarity;

FIG. 2 is a process flow chart indicating the common process development and production elements of general production systems as interfaced with the control and design system of the present invention;

FIG. 3 summarizes the overall high level features of the design, planning and exploring modules of the system of the present invention;

FIG. 4 is a screen shot of a process from the design module, with a detailed equipment and process procedure window opened for a selected process step;

FIG. 5 is a screen shot of FIG. 4 with a floating overlay of the generic standards for the process such as minimum FDA required standards;

FIG. 6 is a screen shot of a time spread of procedures with critical path steps being called out;

FIG. 7 is a run time snap shot of the process with indications of which steps have already been done, which steps remain to be done and which are currently being done;

FIG. 8 is a batch review screen shot showing which steps were executed and which were not, together with a control system pane with measurement values;

FIG. 9 is a screen shot of material genealogy showing how a suspect material is utilized, with tracking details;

FIG. 10 is a block diagram of the design module components with an interface between process model, plant model, operating or control model and the master data base;

FIG. 11 is a block diagram showing the application of singly entered limit parameters throughout the manufacturing system;

FIG. 12 is a block diagram showing various related process models with feedback engendered variations;

FIG. 13 is a system monitoring screen shot showing overriding limit definitions in the design process model;

FIG. 14 is a system monitoring screen shot shoving how the limits are enforced in the design stage of the operating model;

FIG. 15 is a system monitoring screen shot showing how the limits are verified against actual production runs in a batch review; and

FIG. 16 is a system monitoring screen shot illustrating phase parameters showing spreadsheet data built from a model.

### DETAILED DESCRIPTION OF THE INVENTION

The present invention comprises an integrated automated manufacturing system with overriding computer control, as applied to a batch manufacturing process particularly of chemical and food products and in particular pharmaceuticals and biologicals. A closed informational loop is effected from initial design through feedback evaluation comparing design (what was planned) to actual production events with real time comparison with options to automatically modify the plans.

Batch systems generally involve the production of at least two products on a line or at a production site, with the requirement of resource and production time sharing. The manufacturing system of the present invention includes design of the manufacturing process (design module) with the design modeler components of:
i. process (overall production process such as synthesis steps in chemical or pharmaceutical production),
ii. plant (consideration of plant resources such as equipment) and
iii. control (operative controls of the equipment and processes such as temperature parameters and valve openings and closings) models;

Also included is planning of the system (planning module) which includes materials (availability), and scheduling, with interfacing with supply chain, inventory management, purchasing and other financials; and exploring of the system (exploring module), for real time feedback control in a quality control (qc) mode, for shift management control, performance management and optimization, batch and cross batch analysis and review and providing a picture of process capability for process limits and possible refinements.

In accordance with the present invention the system comprises a single distributed data base linked to all of the design, production and feedback/qc functions to ensure invariable data and instructions. The system is initially “educated” with a wide ranging distributed data base for all products being produced and available equipment at a single or multiple manufacturing sites. The distributed data base is a single source of information for the system whereby entered information is maintained at all stages, thereby obviating the need for data re-entry with the possibility of error.

As necessary and desired, and in accordance with the definitions as set forth in S88, the data base contains, for a single or multiple processes, any or all of:
Operation definitions
Operation step definitions (equivalent to generic phases)
Phase definitions (site specific phases)
Product step paths (for drugs and chemicals, defines synthesis steps)
Phase maps (translates operation steps into phases)
Operation step maps (translates operations into operation steps)

These are in turn linked to:
Reaction definitions
Material definitions
Equipment details (size, material of construction, etc.)
Resources (shared equipment)
Components (equipment capabilities)

The above, with reaction and maternal definitions, are particularly related to chemical and pharmaceutical manufacture. Analogous definitions of product components are relevant in other non-chemical product manufacture

Impressed on the above data base items are:
Dimension parameters (pressure, temperature, etc.)
Engineering units (° C. ° F., etc)
Parameter definitions (target-temperature, charge-quantity, etc.)

The above data are defined in the data base by a builder module.

Using data sourced from a process history update service, the data base maintains:
Material history with tracking, subdivision (warehouse preparation) and packout (bulk packaging);
Process control history with alarm events, batch events and operator actions;
LIMS (laboratory information management system) with sample results and sample alarms;
Running comment history.

These data are collected from systems such as an MTS (material tracking system), a PCS (process control system), and a LIMS (Laboratory Information Management System). These systems are pre-configured and approved through a campaign definition component, which also defines, when appropriate, input lot assignments from inventory to specific batches.

Another layer of the database is comprised of plant models, operating models, process models, equipment candidates and schedules.

This database layer is linked to design and planning modules of the system as a basis for the integrated, intelligent design and planning functions. The design and planning modules are configured to set the appropriate parameters, as derived from the data base, in the construction of an operation spread sheet.

The design module is comprised of three components all of which have a common function of ensuring correct process sequence and limits compliance (e.g., for drugs—as required by the FDA). A first component is a Process Modeler which defines the essential process operating sequence: key reactions, key operations and Regulatory Ranges/Limits. A second component is a Plant Modeler which: Provides Operation to Operation Step Mapping, identifies viable equipment options, identifies ancillary equipment options, provides batch size scaling and provides equipment selection impact on batch data. The third component is an Operating Model which provides.

i. equipment assignment,

ii. operation Step to DOCS (distribution control system) phase mapping,

iii. phase parameters with review and verification,

iv. batch instruction generation and control recipe generation.

A simulation object model in the design module provides graph management, and calculates on a detailed operation step basis, mass balance, thermodynamics, reactions, time-cycles (including critical path analysis), environmental emissions and resource contention. With the database “instructional” information the design module is adapted to formulate and construct the operation spread sheet.

The planning module contains a define/edit control of production goals tied into a plant schedule with an edit campaign processing order (editing to ensure that higher priority item gets precedence in the campaign) and generate/edit prior steps campaign (multi-step defaults are implemented if necessary for process and plan). These are linked via edit campaign properties with alternative plant model (including alternative plant models at different manufacturing sites), setup/cleaning times and prior step safety buffers to a schedule generator optimizer component for each campaign (by processing order). This component calculates the earliest possible campaign start time, and finds the earliest time slot where a viable equipment train is available. The component also breaks equipment candidate ties of a choice of equipment for required processes, by considering equipment cost, impact on time cycle, equipment utilization, equipment idle time and number of components.

An interface component between the design and planning modules provides the planning module with detailed design data which comprises plant selection, component scoring, candidate equipment and preferred equipment. A general system use-interface shell provides an application tool framework, a navigation tree, a change distribution manager, a menu manager; a command router and a toolbar manager. A common services framework includes a user comments manager, a user preference manages, and capability of entering electronic signatures. The framework also includes access security, authentication and details of role management. The Common Services Framework also provides all modules of the application and database with version control, an audit trail, an exception manager (with error handling and tracing), data access & caching and user help. An active shift server is linked to an active shift database and an active schedule server is linked to an active schedule database, providing real-time update of production history, current production status, and future projected events.

A feedback/quality control module of the system, also called an exploring module, oversees the production system as batch releases and provides a cross batch view, a model view, a schedule view, a material genealogy view, an instruction view and a shift view. This permits shift management, batch review, cross-batch analysis (with deviations, changes and general review), process capability evaluation and performance management and optimization.

The exploring function, together with batch analysis, permits tighter parameters with increased yields and higher purity than batches run at the compliance levels. This provides more economical product yield while also increasing quality of the produced products. Changes deemed necessary by the exploring function for scheduling control (e.g., with critical path elements) are carried through to the spread sheet and the production process and scheduling are automatically modified, all in real time. The exploring function, because it is in a closed informational loop with the design module, effects a full scale comparison between the planned operation and actual events, with feedback for correction and with provision for automated real-time scheduling changes. As a result, of the constant feedback and control, regulatory limits, such as required by the FDA (or other regulatory authorities) are constantly adhered to and monitored in real time, with resultant minimization or elimination of batch certification

### DETAILED DESCRIPTION OF THE DRAWINGS AND THE PREFERRED EMBODIMENT

The Overall System and Distributed Database

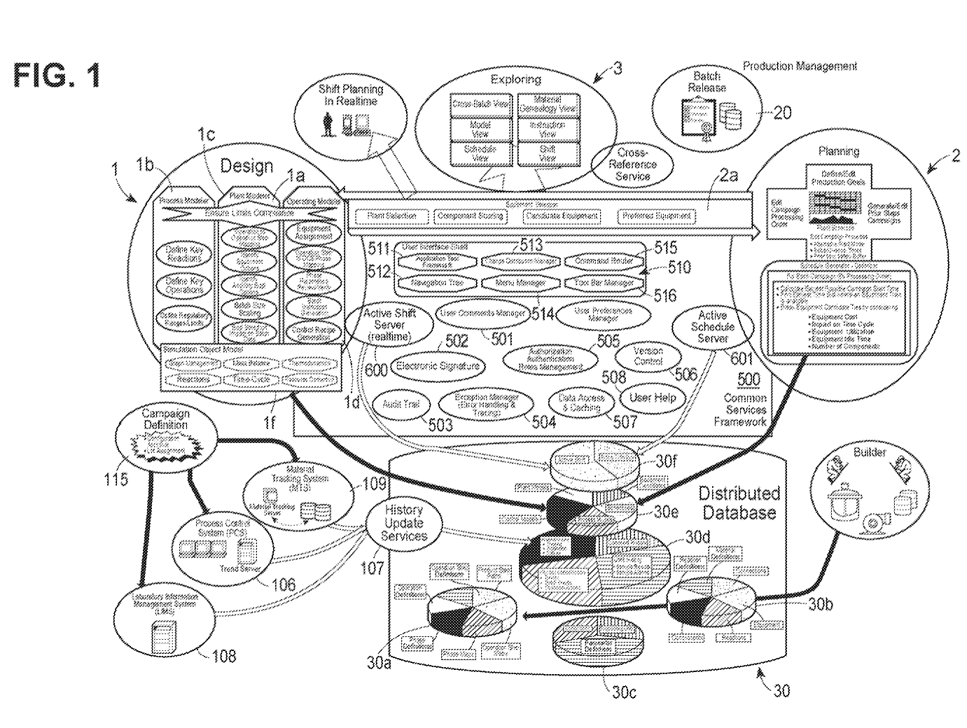

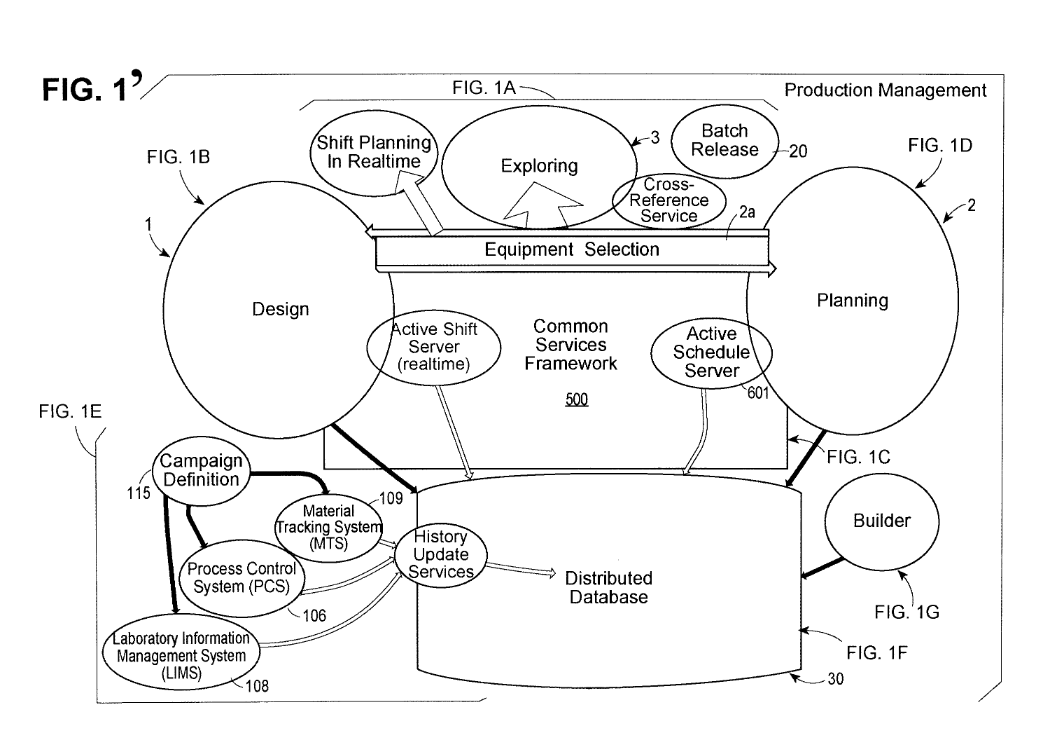

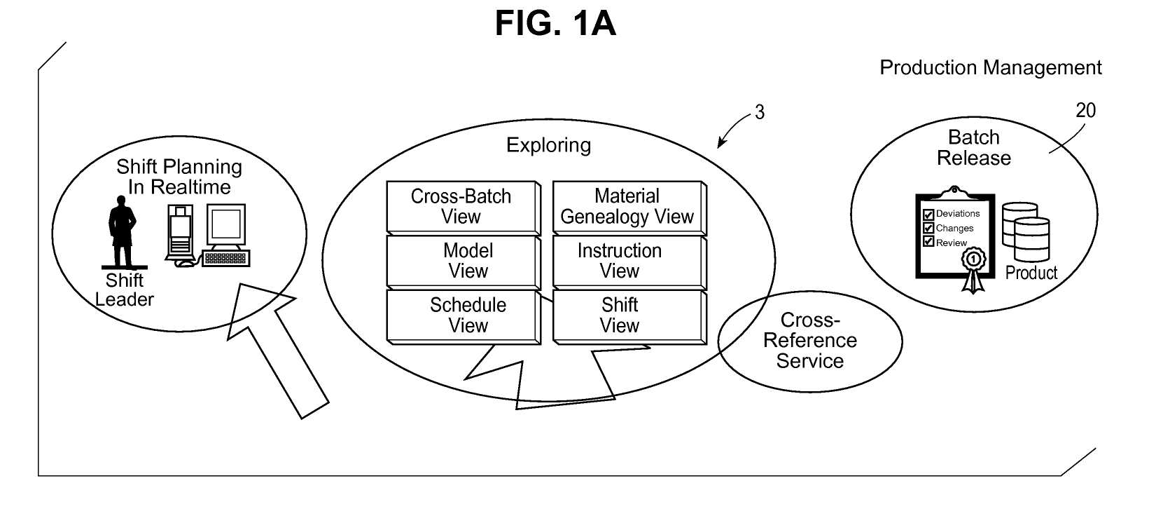

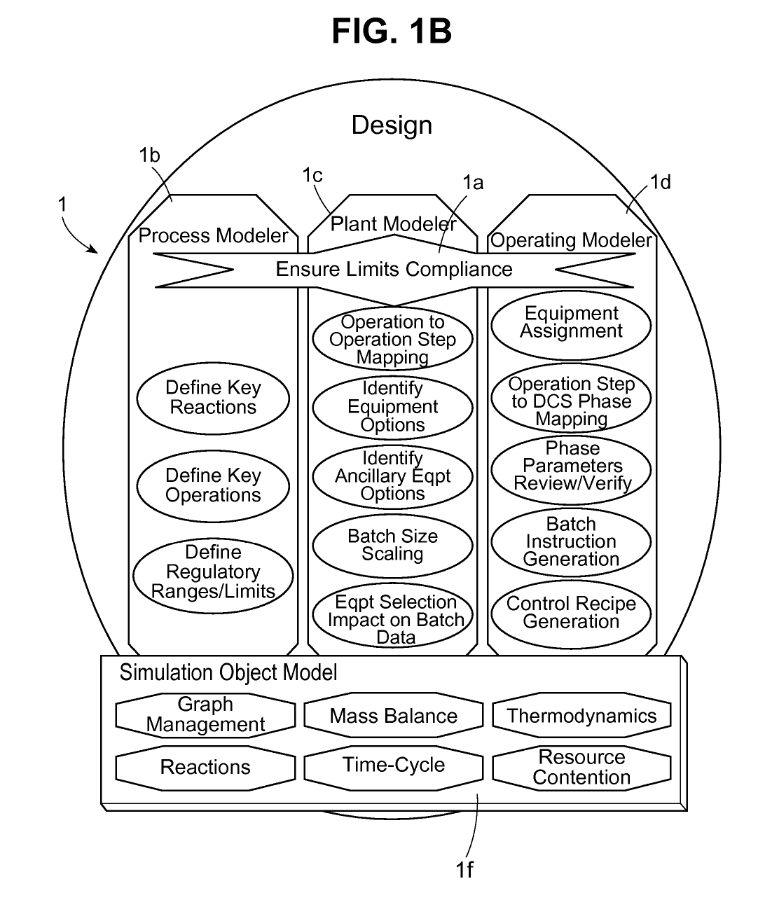

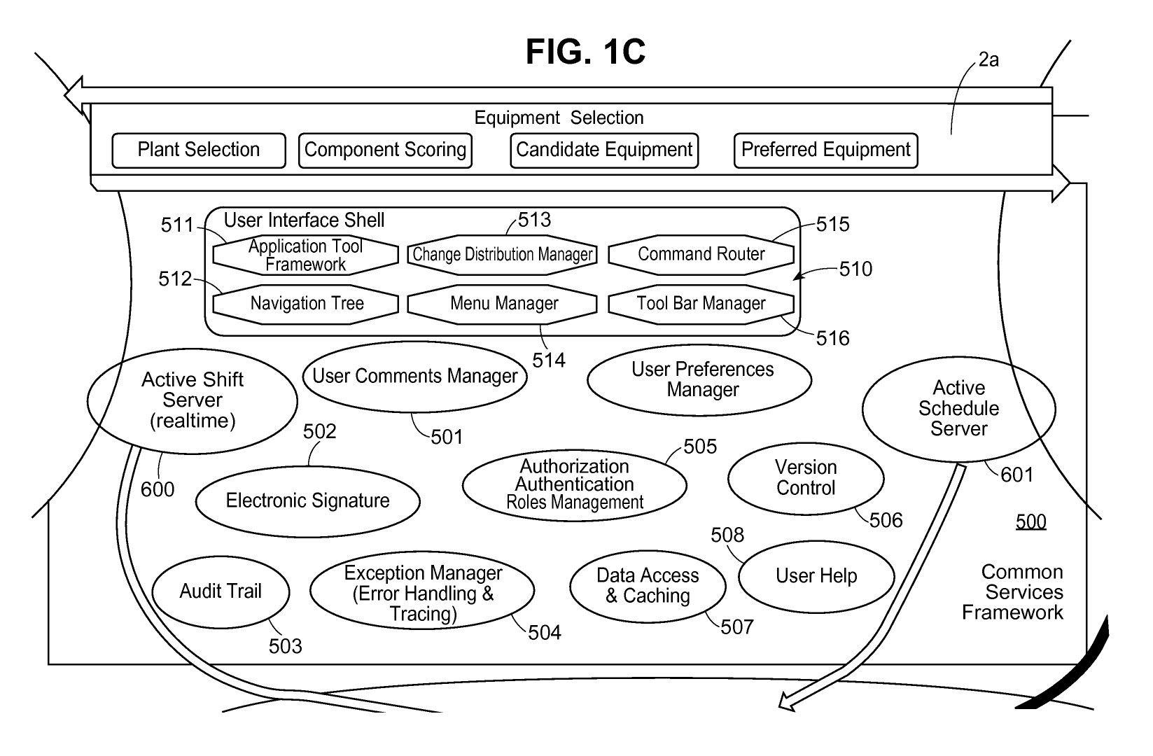

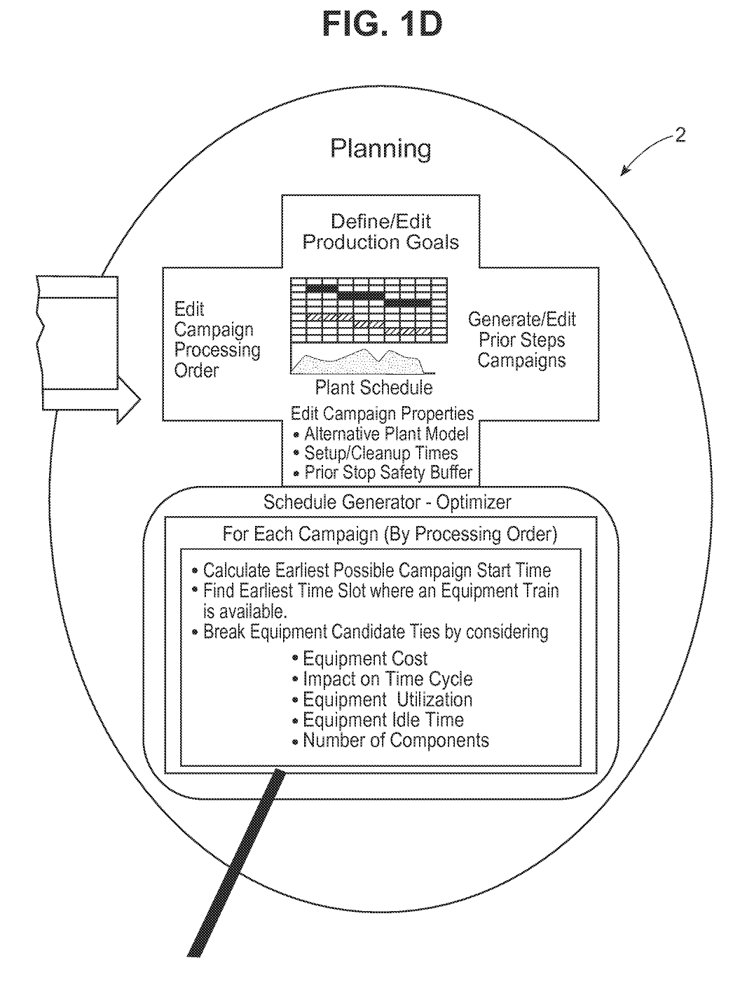

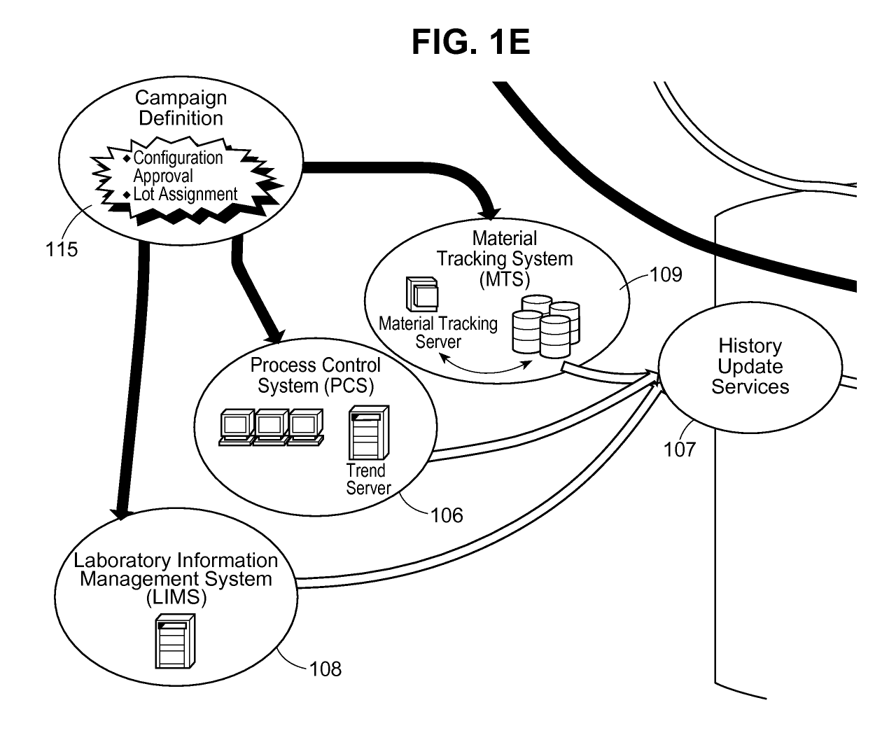

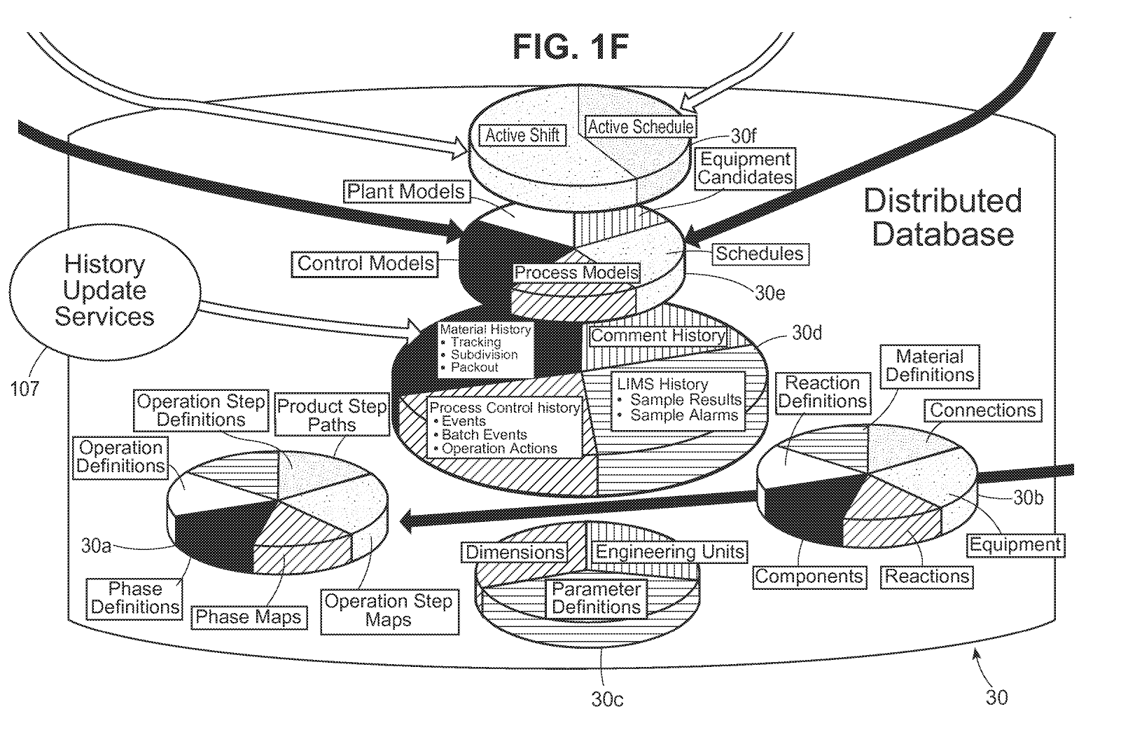

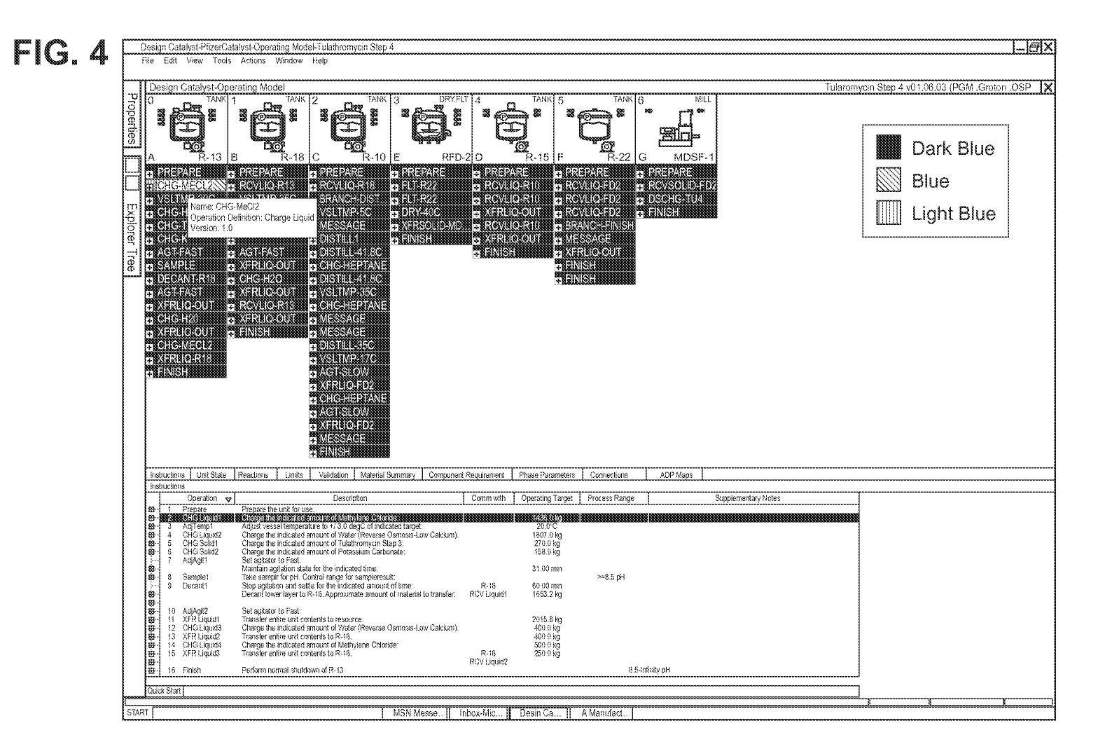

In accordance with the present invention an overall automated production system is provided which integrates a first control or design module encompassing detailed process design with manufacturing planning, and which configures a second planning module of plant floor execution systems (e.g. Process Control Systems, Material Management and Tracking Systems, Electronic Work Instruction Systems), and a feedback/quality control module which organizes/analyzes plant floor information (e.g. analog instrumentation, alarms, events) by automatically associating this information with related design and planning data, thereby enabling the automatic verification that the process executed within design limits and on schedule while highlighting any deviations. FIG. 1 and expanded views 1A-1G set forth the functional parameters and components of the design module 1 for pharmaceutical manufacture, the planning module 2 and the exploring or feedback module 3 and their relative interaction with each other and distributed database 30, having general and specific information suitable for construction generation of spread sheet operation templates shown in FIGS. 4-8.

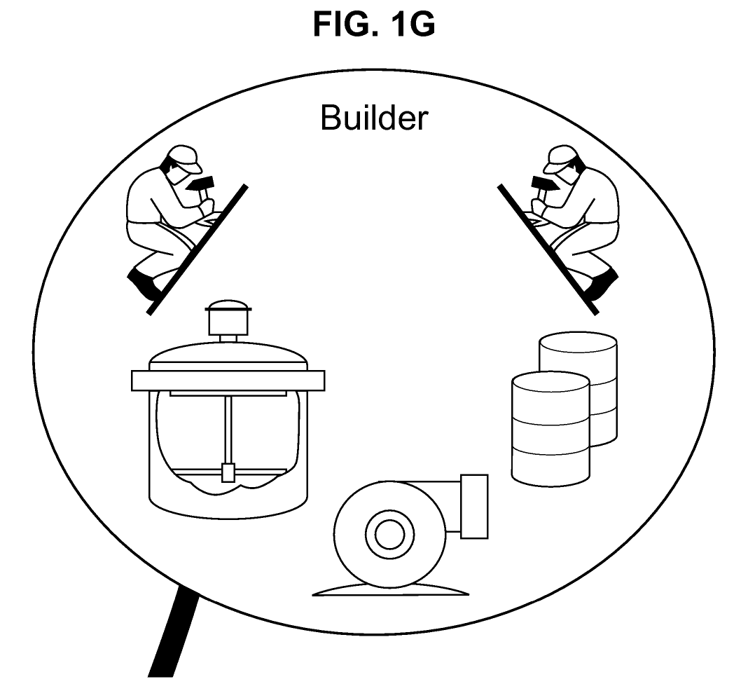

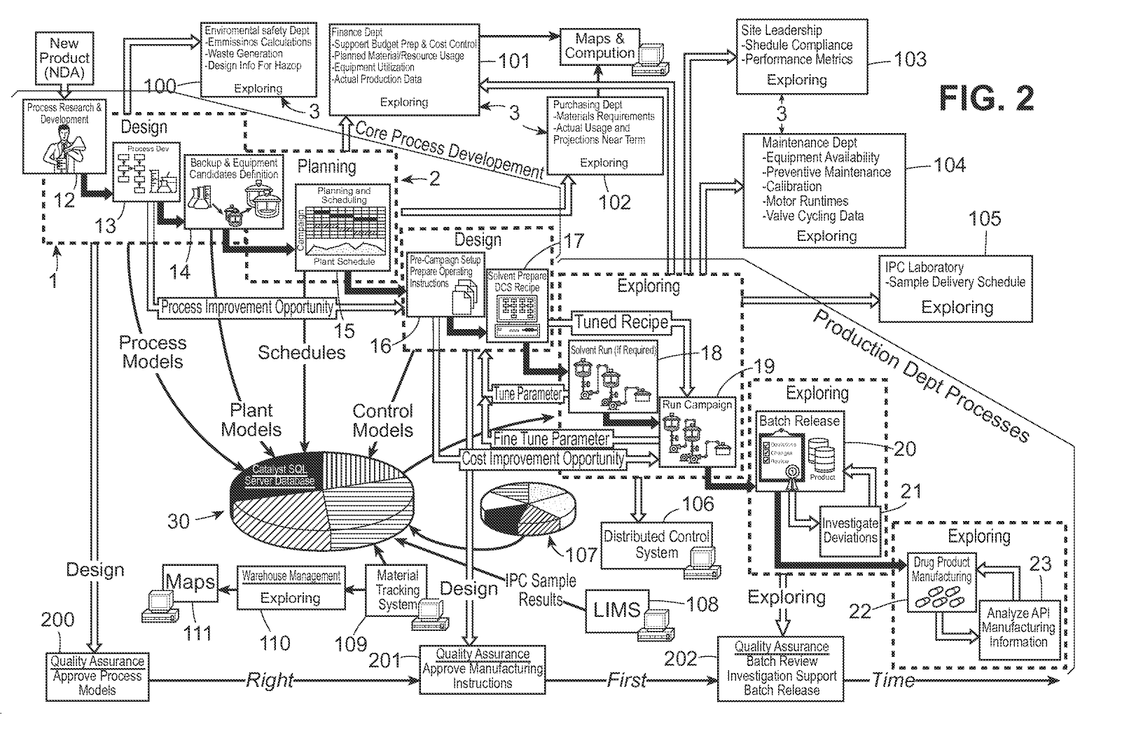

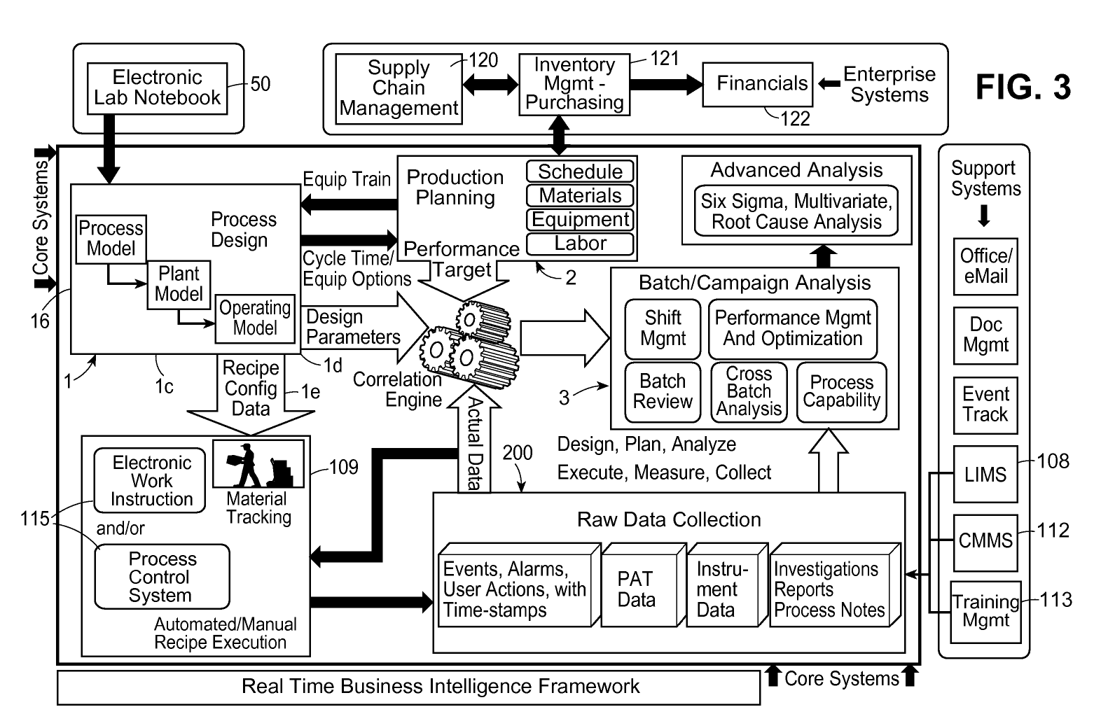

FIG. 2, details steps in the core process development 10 and production process 11 with the elements of the present system impressed thereon in the batch manufacture of a drug. FIG. 3 depicts the high level interactions between the design module 1, the planning module 2 and the exploring module 3 with interaction of the system with external parameters including supply, inventory and financials as well as external support systems.

For the batch manufacture of a drug the process steps begin, as sequentially shown in FIG. 2, with the submission of an NDA (new drug application) to the FDA (Food and Drug Administration) and the plant is geared up for production. The process proceeds sequentially from Process, Research and Development 12 through manufacturing process development 13, scale-up & equipment candidates definition 14, through planning and scheduling 15. A next step 16 is a pre-campaign setup to prepare operating instructions and then preparation of a DCS recipe step 17. A solvent or water run 18 follows (if required) and then a run campaign step 19. A batch release step 20, with deviation investigations 21, is next. In the final step of the process 22 drug product manufacturing begins with 23 analysis of API manufacturing information. In order to effect information distribution throughout the system a SQL server database 30 receives information during the steps: process models from steps 12-14, plant models from step 14, schedules from step 15 and control models from steps 16 and 17. Information from the database is then distributed to steps 18 and 19 for the running of the solvent run and the run campaign respectively.

As shown in FIG. 2, points of the various steps can exert operational influence on other steps whether directly or indirectly. Thus, manufacturing process development data in step 13 may be used as an opportunity to improve the pre-campaign setup and preparation of the operating instructions of step 16. Similarly data of the pre-campaign setup and preparation of the operating instructions of step 16 can in turn provide a cost improvement opportunity with respect to the actual running of the campaign in step 19. Preparation of the DCS recipe of step 17 provides data to tune the recipe for step 19 in running the campaign as well as tuning and fine tuning parameters in steps 18 and 19 of solvent run and running the campaign.

The computer controlled integration system of the present invention performs a multitude of functions. At step 100 the design module 1 interacts with the exploring/feedback module 3 with design considerations of environmental/safety, i.e. providing data for emissions calculations, waste generation, and design information for hazardous operations (hazop). At step 101 the planning module 2 (steps 14 and 15) interacts with the exploring/feedback module 3 in providing finance information data relating to support budget preparation and cost control, planned material/resource usage, equipment utilization and actual production data. At step 101 the exploring/feedback module 3 also receives data from the solvent run and campaign run steps of steps 18 and 19 to support the financial information. In a related function, at step 102, the planning module 2 and steps 18 and 19 provide data for purchasing requirements including material requirements and actual usage and near term projections. Steps 101 and 102 feed and prepare information for the material accounting system (maps) and the accounting system (computron) at 102a. For management oversight and control, steps 18 and 19 provide oversight managers with schedule compliance and performance metrics data at step 103. Maintenance is also provided with data from steps 18 and 19, at step 104, regarding equipment availability, preventive maintenance requirements, calibration, motor runtimes and valve cycling data. Data from steps 18 and 19 is sent, at step 105, to an IPC laboratory for sample delivery scheduling and to a distributed control system 106 with plant recipe control. A process history is then transmitted therefrom to data historian data base 107 and then to SQL server database 30. Data is also transmitted to the database 30 from LIMS at 108 and from a material tracking system 109. The material tracking system 109 also transmits data to warehouse management 110 which is, in turn, sent to the material accounting system (maps) at 111. The campaign definition 115, with configuration approval and lot assignment, feeds data and to the MTS 109, PCS (process control system) 106, which runs the production, and LIMS 108. The data base 30 provides data for the steps 18 and 19. Three quality assurance steps at 200, 201 and 202, require approval of the process models, manufacturing instructions and batch review with investigation support and batch release respectively.

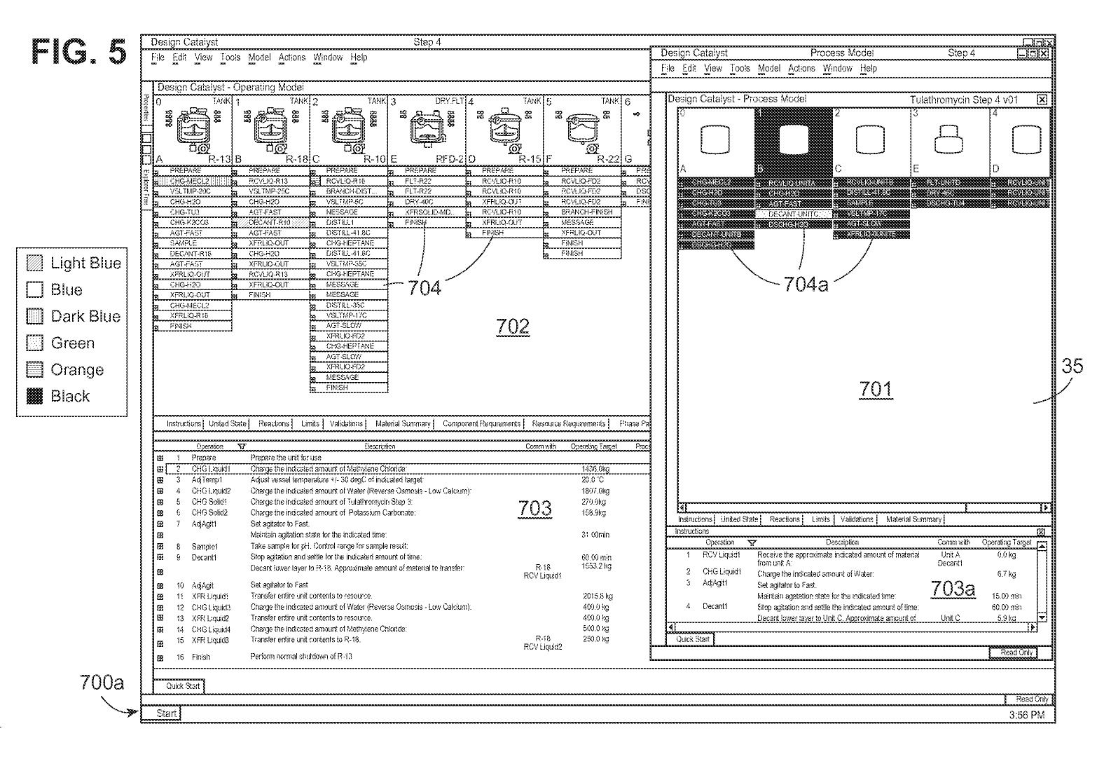

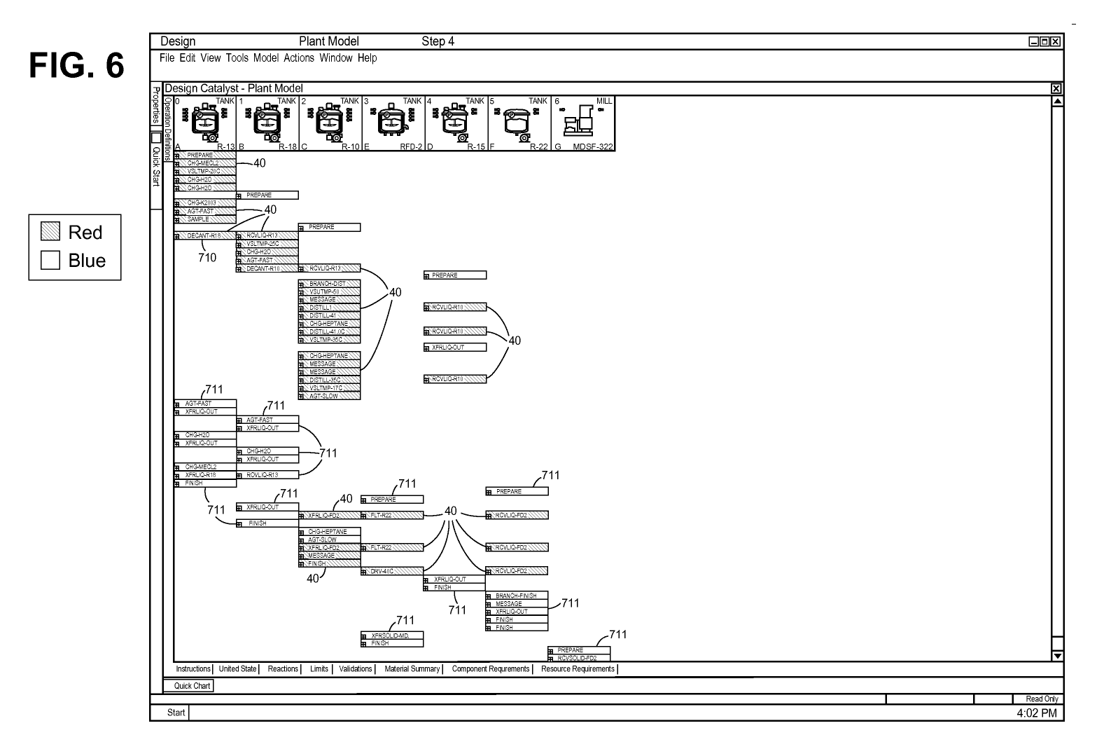

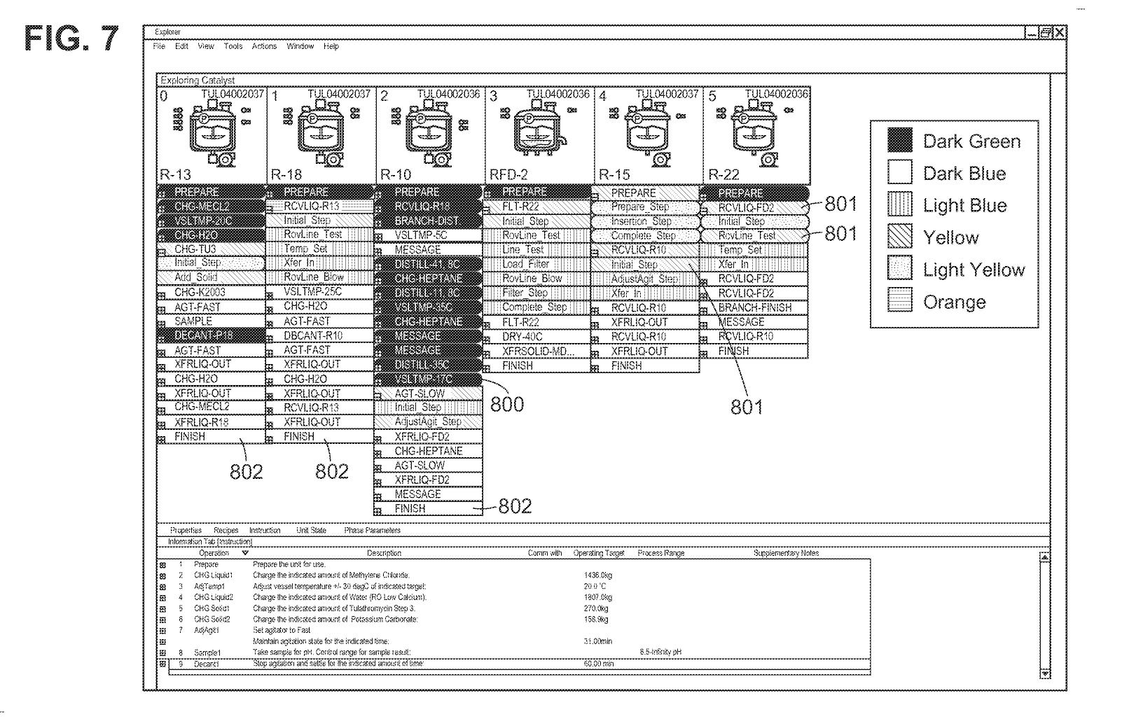

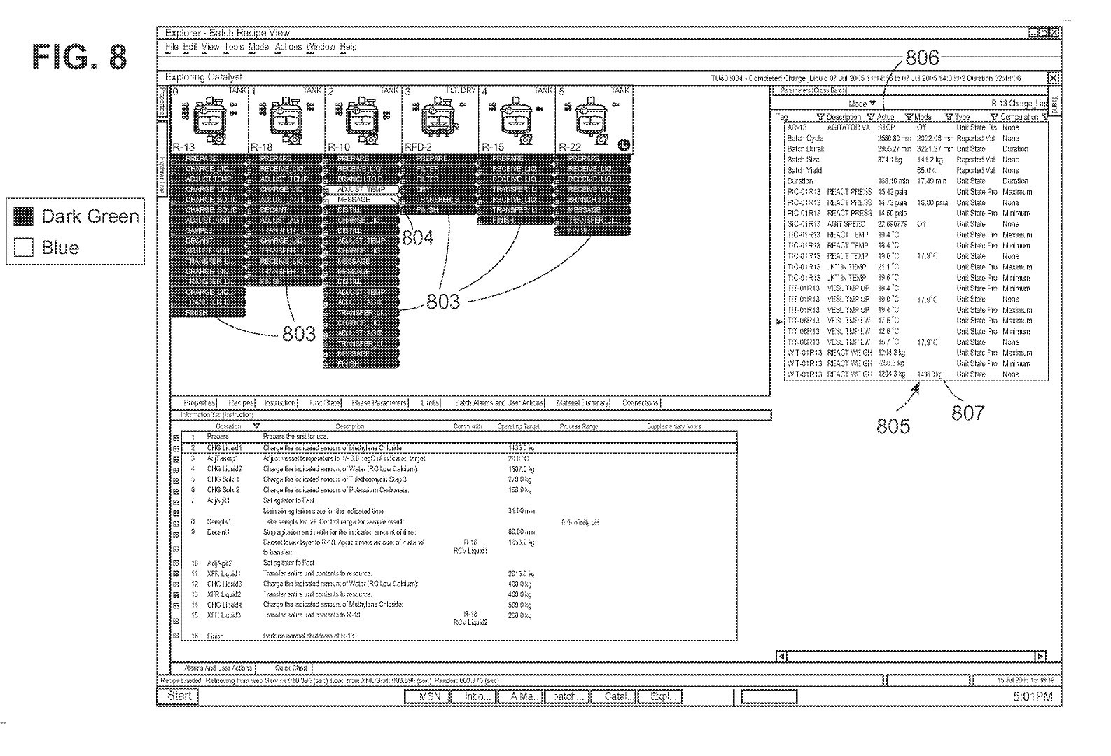

Data base 30 (as more clearly seen in FIG. 1) maintains an active shift and schedule of the manufacturing plant 30f, with an interface and information about various models of the design module at 30e, of plant control, process models, and schedules. The data base further contains a full history and tracking of the manufacturing process(es) including material process control and LIMS history at 30d. Dimensional parameters, engineering units and parameter definitions are maintained at 30c. Builder 31 defines operational items of 30c into the data base at 30b and connected data base element 30a. Reaction definitions. Material definitions, Equipment details, Resources, and Components are contained in 30b. Operation definitions, Operation step definitions, Phase definitions, Product step paths, Phase maps, and Operation step maps are contained at 30a. The database 30 is interfaced with all of the modules of design 1, planning 2 and exploring 3 with unitary constantly updated data. This enable the operator to obtain real time snapshots of production operation as shown in FIGS. 7 and 8 as well as planned processing views in FIGS. 4 and 5 (with the latter further having a view of overriding FDA processing parameters 35). The critical path steps 40 (steps involved in timing of the production) of FIG. 6 are constantly monitored for real time readjustment.

Common services framework 500 provides managerial functions of user comments 501, electronic signature 502, audit trail 503, exception manager with error handling and tracing 504, authorization, authentication and roles management 505, version control 506, data access and caching 507 and user help 508. Within the framework is a common user interface shell 510 with functions to allow user computer control, with the functions of application tool framework 511, navigation tree 512, change distribution manager 513, menu manager 514, command router 515 and tool bar manager 516. Within the framework but separately connected to the database 30 are active shift server 600 and active schedule server 601

FIG. 3 provides an overview of the manufacturing system of the present invention as it is integrated with external processes and steps. Thus, lab data in an electronic notebook 50 (or a Word or Excel file) is entered into design module 1, with components of process mode 1b, plant model 1c, and control or operating model 1d. Recipe configuration data 1e is sent for material tracking 109 with electronic work instruction and/or process control system 115 for automated/manual recipe execution. Raw data is continually collected at 200 with events, alarms, user actions with time-stamps. Also collected are PAT data, instrument data and investigations, reports and process notes. The design module 1 interacts with the planning module 2, with plans relative to cycle time/resources, for schedule and material related planning. With planned production targets sent from planning module 2 to exploring module 3, and raw data collection from 200 with design, plan analysis, execution, measurement and collection, the exploring module 3 effects batch review, cross batch analysis, evaluates process capability, provides performance management and optimization and aids in shift management. The planning module interacts with external support systems of supply chain data 120, inventory management and purchasing 121 and other financials 122. The raw data collection 200 is supplemented by external support systems of 121 LIMS 108, CMMS (computerized maintenance management system) 112 and training management 113.

The Design Module

The design control module 1 of the present invention, as depicted in FIGS. 1-3, provides a process design system, with reference interface with the distributed, prior populated, data base 30 with real time updating and having general and specific process (30d, 30e), equipment and scheduling information (30b, 30e, 30f). The design control module 1 takes any batch manufacturing step and combines the generic process sequence with equipment specific design parameters (e.g. materials of construction, volumes, capabilities) as well as materials property information to produce a detailed model comprising the following components: Operation Sequences, Operating Instructions, Mass Balance, Materials Summary, Reaction Summary, Equipment States, Time Cycle, and Processing limits. Furthermore, the system uses the operating sequence and design information to calculate detailed operating parameters that are used to automatically configure plant floor execution systems.

Information input into the design module is retained through all subsequent steps and modules, thereby eliminating a key quality control factor of data transcription errors, by only inputting data once.

With reference to the drawings, in FIG. 1 and FIGS. 1A-1G, design module 1 is initially impressed with compliance limits (for drugs-FDA limits) as overriding element 1a for all component configurations. The design module comprises process modeler 1b, plant modeler 1c and control or operating modeler 1d. With input from database 30, process modeler 1b defines the key reactions and operations with definition of regulatory ranges and limits for the manufacturing process. The plant modeler 1c provides operation to operation mapping as well as batch size scaling, all in relation to available (or necessary) equipment. The plant modeler identifies equipment options, and ancillary equipment options as well as determining the impact of equipment selection on batch data. The control or operating modeler 1d interacts with the data of the process and plant modeler and data from the planning module 2 of equipment use scheduling parameters, information and planning of plant selection, component scoring (evaluation of equipment), candidate equipment and preferred equipment are interactively interchanged at 2a between the planning module and the control & plant modelers. The control modeler 1d establishes equipment assignment operation step to DOS phase mapping, review of phase parameters with verification, batch instruction generation and control recipe generation. The components of the design module provide a simulation object model 1f which provides information of what the system is designed to do which is then used in a comparison to what the system actually does by the exploring module 3.

The Manufacturing Process Map of FIGS. 4 and 5 provides screen 700 and 700a views to navigate the entire process design. The process design is a 3-tiered modeling environment where the top process model 701, shown in FIG. 5, is a level which contains process and constraint information (e.g. regulatory requirements), the middle plant model level 702 adds class based equipment requirements, and the lower operating model level 703 adds detailed operating parameters with process limits that are enforced across the model hierarchy. Level 702 is broken down into operating steps with the entire process shown in collapsed segments 704, arranged sequentially beneath the appropriate identified (by type and internal tracking code) equipment with which the operations are linked. Selection of an operating step in a collapsed segment 704 opens detail window 703 of operation step parameters. The operating steps in regulatory overlay process model 701 are depicted with collapsed segments 704a which are similarly expanded to window 703a with minimal regulatory details and parameters. The operating model is linked to the regulatory details and parameters to ensure that there is no deviation beyond the set regulatory requirement limits and that compliance is readily observable.

FIGS. 4 and 5 depict a user interface which shows connectivity between related models in the hierarchy of the design. The Mass Balance includes Reaction processing, and Time Cycle analysis and this highlights the critical path (steps which affect timing of the process) shown in FIG. 6 as step elements 710. Non-critical steps 711 do not affect the timing of the process.

Equipment requirements are assessed based on processing sequence, using an algorithm that consolidates requirements, when appropriate, and matches requirements to suitable plant equipment. The design module provides translation of general process sequences to equipment class specific operating steps. The system includes intelligent parameter defaults based on generic categories, which results in a dramatic reduction in required user data entry. The system preferably utilizes process sequence building blocks that are user configurable and uses user preferred engineering units for display. The system provides operator instruction generation based on operating steps, with user defined operating parameters and process limits.

Configuration of plant floor execution system is with a tabular summary depicting equipment options vs impact on batch size and time cycle that may be used as an input to a planning system. There is preferably an across system sharing of models. Top and middle-tier models are constructed such that they contain generic requirements and can be “fit” to any local equipment database in another similarly configured system.

The Planning Module

The Planning module 2 shown in FIGS. 1-3 includes a manufacturing planning system that schedules plants by matching process design requirements to available plant equipment, utilizing an algorithm that meets scheduling goals as early as possible, with the capability of using design data to modify batch size to match available equipment capacity.

Equipment requirements for each scheduling goal are obtained from process models with calculation of overall materials and resource requirements across an entire production schedule. The scheduling algorithm itself is part of the Planning module.

Exploring Module

The Exploring module 3, shown in FIGS. 1-3 comprises a system configured to correlate design, planning, and execution data in real-time to provide real-time production performance management, real-time quality analysis, and real-time updating of start times for future events. The schedule is adapted to update itself with current state via an interface with the execution environment (known as “the Active Schedule”). Alerts are generated when tasks in the Active Schedule slip by a user definable amount vs. the current “base schedule”. This enables real-time schedule compliance reporting with no user interaction.

The Exploring module is configured to provide real-time calculation of upcoming tasks on a shift, based on current state plus design data or a moving average of historical execution times.

A campaign status user interface that displays past, present and future in one view (in the explorer function) is depicted in FIG. 7, which is a real time view of the design process of FIGS. 4-6 being carried out. Steps 800 are those which have taken place prior to the snapshot. Steps 801 are taking place at the real time of the snapshot and steps 802 remain to be taken.

A batch review user interface that integrates design, planning, and execution in one view is depicted in FIG. 8. Steps which have actually taken place are noted as 803 and those which did not take place are noted as 804. Trend exploration is adapted to be driven from a batch view and cross batch views as mapped on generated graphs. The chart 805 in FIG. 8 provides a further comparison of actual values 806 as compared to expected or modeled values 807.

Process constraints (limits) as defined during design, are compared to actual execution values in real-time to enable real-time batch release. Gross system architecture enables comparisons of manufacturing information across systems.

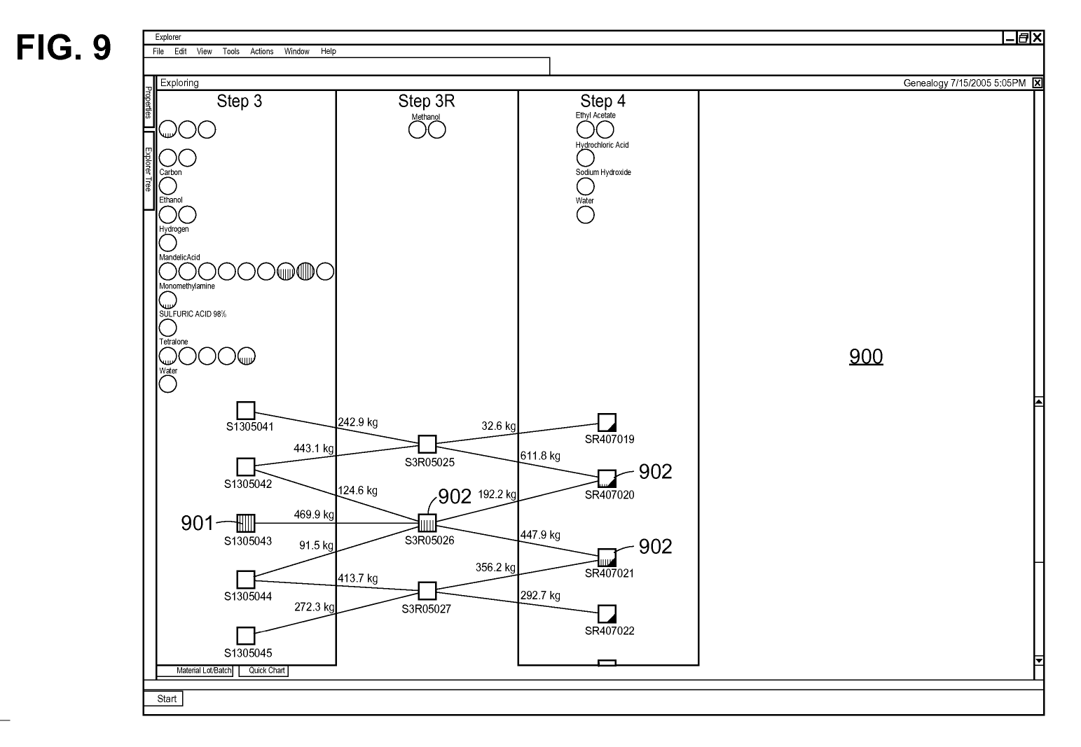

A Material Genealogy user 900 interface enables easy visualization of material lot interdependencies in one view as shown in FIG. 9. A suspect material 901 is tracked through the manufacturing process and identified as being present at steps 902 with relative amounts being depicted as well within each of the identified steps.

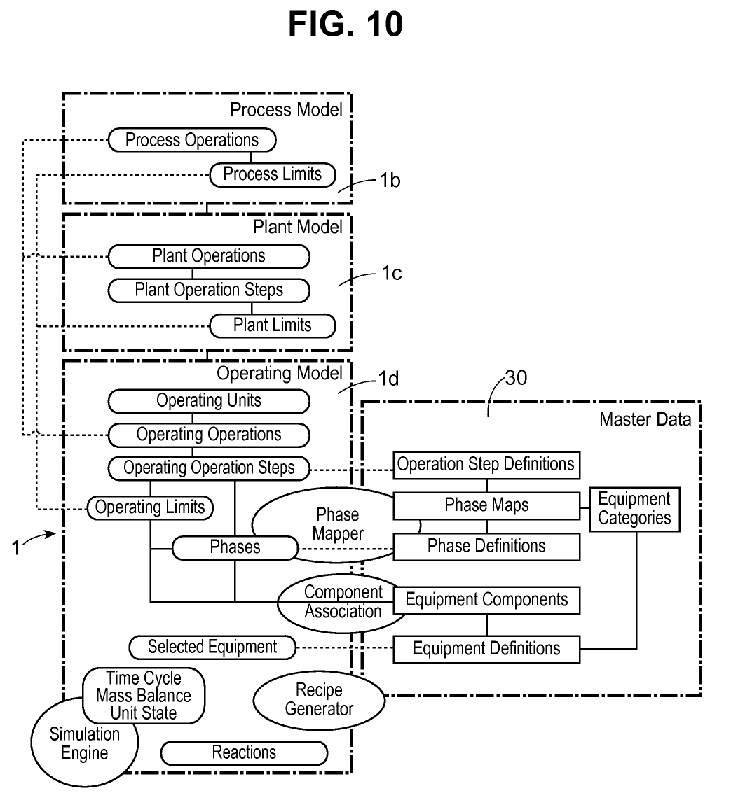

FIG. 10 depicts, in block diagram form the connection between the components of the design module 1 of process model 1b, plant model 1c and operating or control model 1d with basic steps and their interaction with the master data of database 30 as well as a simulation engine 1e.

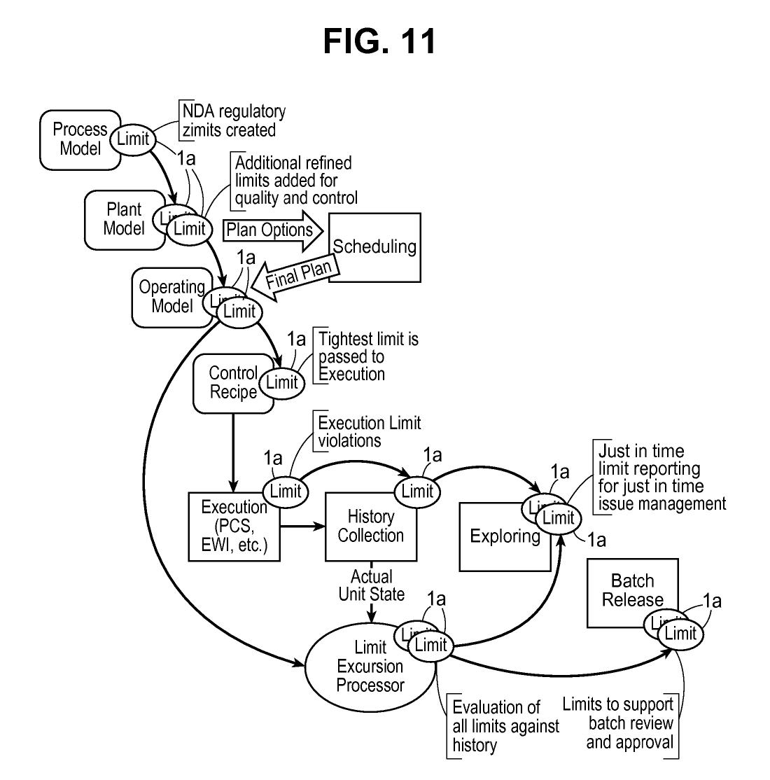

FIG. 11, in block format, depicts the impression of limits (basic FDA requirements) 1a across all of the system modules (with planning being represented by scheduling). Since the limits are enforced across the entire system (product life cycle) and processed in real time, real time batch release is enabled.

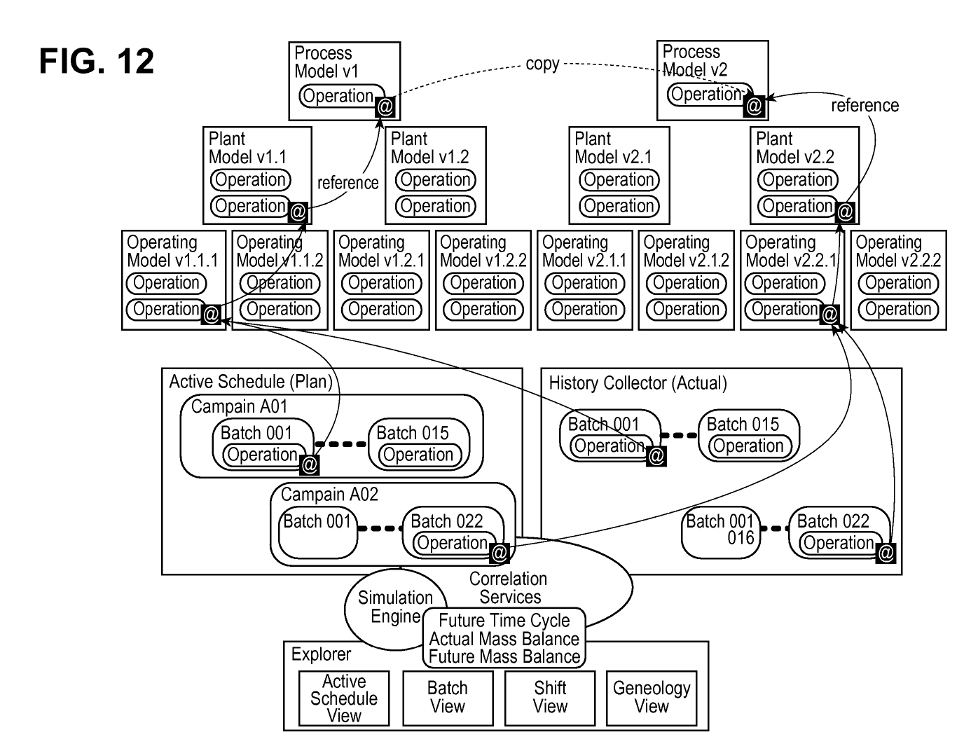

FIG. 12 depicts a multitude of versions, 1; 1.1, 1.2 . . . 2; 2.1, 2.2 . . . and their integration in an active schedule plan with actual batches and correlation.

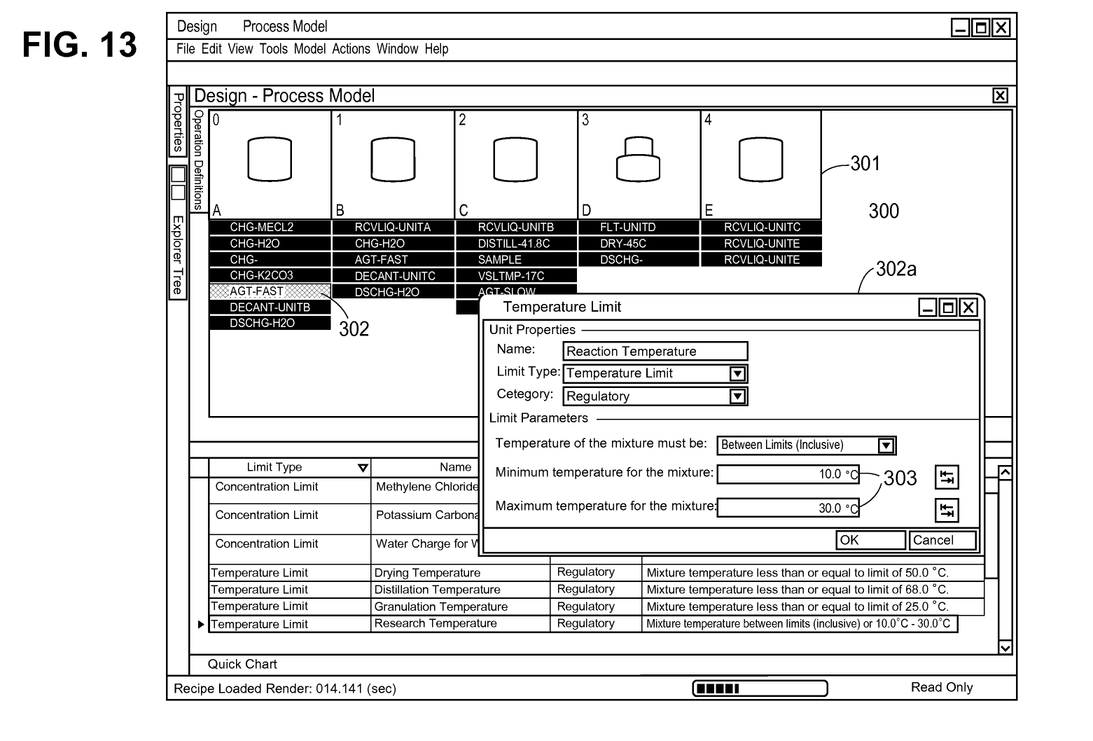

FIGS. 13-16 are screen shots which illustrate the ability of the present manufacturing management system to minimize, if not to eliminate manual entries and controlling document generation and their attendant possible inaccuracies and inconsistencies, without loss of functionality and with enhanced oversight control. Thus, in FIG. 13, a design process model 300 with FDA required parameters 301 is depicted on a viewing screen shot. A window 302a is opened at step 302 to provide the regulatory mandated temperature range limits 303 for that step and to which the process model must adhere. The common present procedure is to create a paper document with this information and to use it for manual checks.

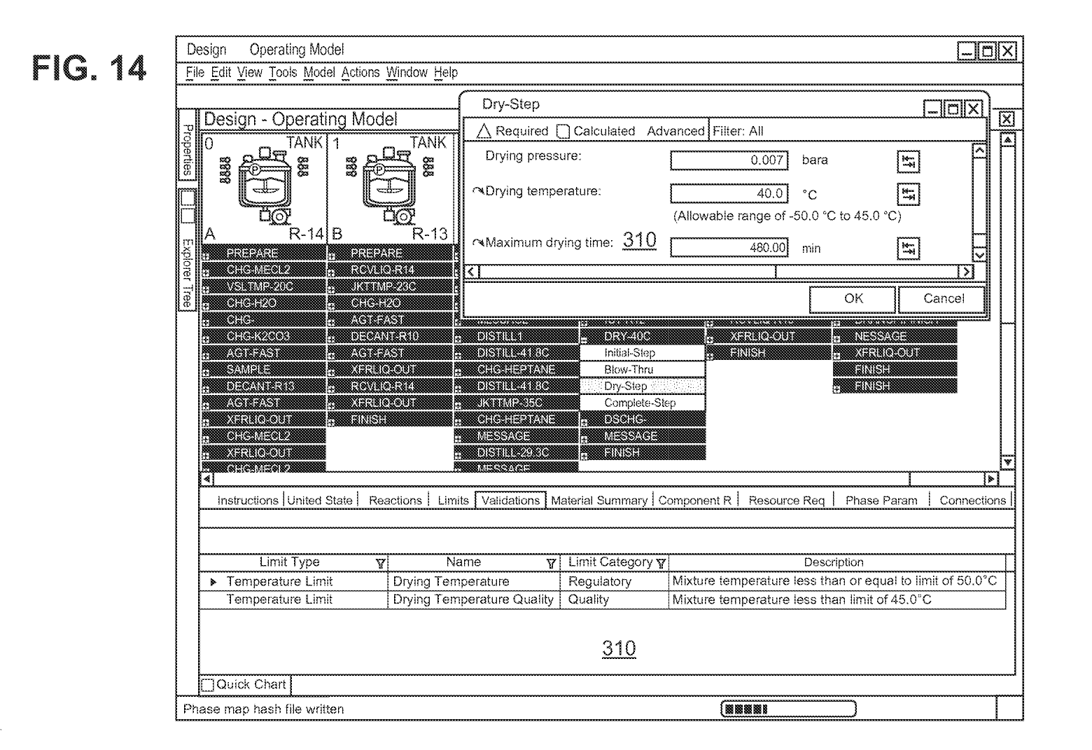

In FIG. 14, window 310 illustrates the application of the regulatory drying temperature limit to a quality control limit in a selected operational step in the system operating model. Typically such verification is effected by a manual comparison with a generated document.

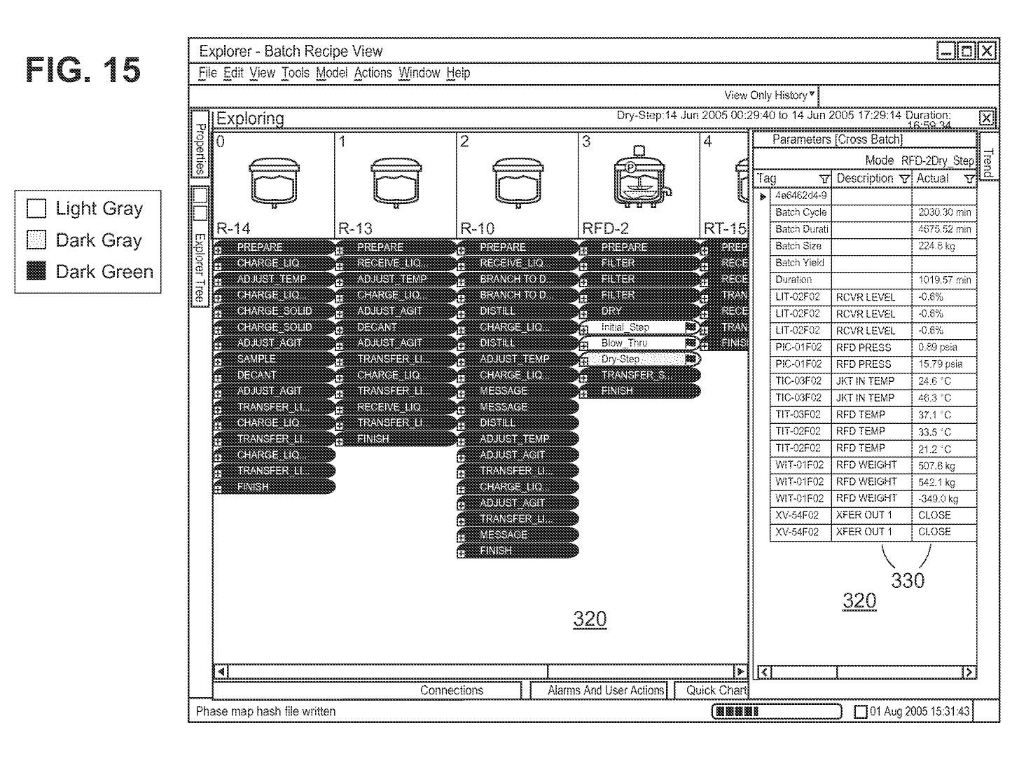

FIG. 15 is a window 320 depicting the verification of the limits against an actual production run with cross batch parameters 330 and actual values during a production run. Again, the prior art and current method is to verify against a document.

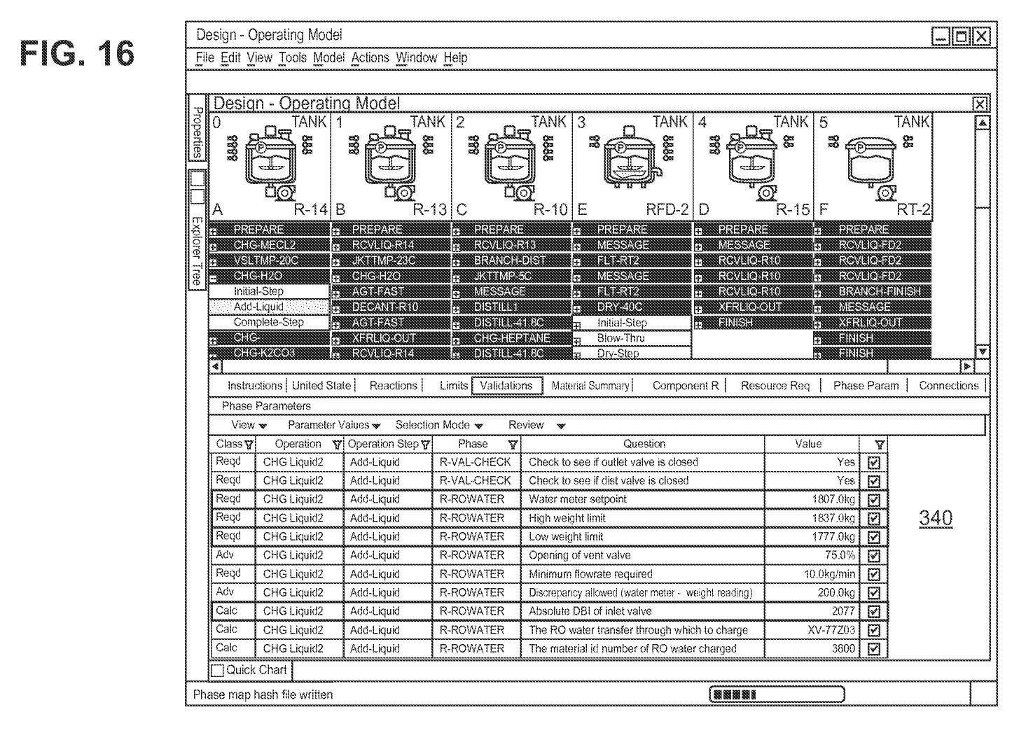

FIG. 16 illustrates phase parameters in window 340 of values (R-VAL-CHECK) and water metering (R-ROWATER) showing spreadsheet data being built from the model. Grey rows are obtained by user entry from a higher level model. Material information is obtained from the database. Equipment information is also obtained from the database. Gathering and entry of such information and the preparation of an operating spread sheet is with manual entries by looking up information from various sources and by doing manual verifications.

It is understood that the above description and drawings is only illustrative of the present invention as particularly applied to pharmaceutical manufacturing. Changes in processes, parameters, equipment components, timing, financial considerations, regulatory requirements (if any) and the like will vary according to the application, industry, plant requirements and product being manufactured, among other considerations and are within the scope of the present invention as defined in the following claims.

What is claimed is:

1. An integrated automated management system for batch manufacturing of products comprising:
a) a database having stored parameters and details of processed materials and components, and equipment used for the manufacturing of products in which at least some of the equipment is common in the production of multiple products, the database containing process models, production schedules and respective use of equipment and shared equipment, the database further comprising means for storage of details of actual production and correlation to expected criteria and optionally to financial, quality and performance criteria relating to said materials, components, equipment and production,
b) a design module for the design of the batch manufacturing process, the design module comprising means to correlate input process sequence details of at least one operating process, with appropriate stored parameters and details extracted from the database, to build process controlling operating spread sheets, with operation steps and allocated and shared equipment, where applicable,
c) a planning module comprising means to enable it to interact with the design module and the database to create production schedules accounting for equipment overlap use and optionally other cost factors and subsequently establishing final projection of time and materials based on available equipment and optionally updating the design module and,
d) an exploring module having means to interface with the database and with the design and planning modules in a closed loop with said exploring module and comprising means to track materials, production requirements, equipment sharing and maintenance along with operating steps and production data.

2. The integrated automated management system of claim 1, wherein the system comprises means for single input of any given data into the system for use by all the modules of the system.

3. The integrated automated management system of claim 1, wherein the exploring module comprises means for effecting a comparison between a planned manufacturing process model of the design module and actual manufacture, whereby deviations therebetween are observed and assessed, with means for optional controlled changes in the model.

4. The integrated automated management system of claim 1, wherein the system comprises means for obtaining real-time analysis of the manufacturing process, at any time, with a graphical information generation display.

5. The integrated automated management system of claim 4, wherein the system comprises means to evaluate, in real-time, actual production status and present it against planned production, and then re-project estimated times for future operating steps, to thereby provide accurate near term planning information.

6. The integrated automated management system of claim 1, wherein the products are pharmaceutical drugs and wherein the operating process comprises the chemical synthesis of at least one active ingredient and/or the formulation of a drug.

7. The integrated automated management system of claim 6, wherein the database contains full input knowledge of all product synthesis requirements and/or product formulation, available equipment capability and production information of all products being manufactured at a local site and/or other linked sites, whereby product production scheduling, with equipment and machinery capability, availability and maintenance, inventory and requirements, are available in real time and are constantly updated for maximum efficiency and product quality.

8. The integrated automated management system of claim 6, wherein the system contains mandated drug regulatory requirements for the pharmaceutical drugs being manufactured and wherein the system comprises means for constantly comparing real time manufacturing parameters with the regulatory requirements to maintain and document compliance of the pharmaceutical drug manufacture and drugs with the drug regulatory requirements.

9. The integrated automated management system of claim 1, wherein the system comprises real time manufacturing feedback with means to permit the immediate taking of automatic or manual corrective measures.

10. The integrated automated management system of claim 6, wherein the design module comprises
i. design of overall production process and synthesis and/or formulation steps in the production of the pharmaceutical drugs,
ii. parameters of plant resources and equipment and
iii. parameters of operative controls of the equipment and processes,
iv. specifications for measured and discrete parameters and actions on devices;
wherein the planning module comprises:
i. parameters of materials availability and process scheduling, with
ii. interfacing with supply chain, inventory management, purchasing and other financials;
and wherein the exploring module comprises:
i. real time feedback control in a quality control (qc) mode, for shift management control, performance management and optimization,
ii. batch and cross batch analysis and review and providing a picture of process capability for process limits and optional refinements.

11. The integrated automated management system of claim 1, wherein the system comprises a single data base linked to all of design, production and feed back/qc functions to ensure invariable data and instructions.

12. The integrated automated management system of claim 11, wherein the system is initially “educated” with a wide ranging distributed data base for all products being produced and available equipment at a single or multiple manufacturing sites; and wherein the database is a single source of information for the system whereby entered information is maintained at all stages of the process.

13. The integrated automated management system of claim 6, wherein the database contains, for a single or multiple processes, any or all of the data of: operation definitions, operation step definitions, phase definitions, product step paths, phase maps, operation step maps, wherein these are in turn linked to: reaction definitions, material definitions, equipment details, resources, and components and wherein reaction and material definitions, are related to chemical and pharmaceutical manufacture and wherein dimension parameters, engineering units and parameter definitions are impressed on relevant items in the database.

14. The integrated automated management system of claim 12, wherein the database comprises means for maintaining the data of material history with tracking, charge, discharge, dispense and package, process control history with alarm events, batch events and operator actions; sample results and sample alarms; and a running comment history, details of plant models, operating models, process models, equipment candidates and schedules, wherein the database is linked to design and planning modules of the system and wherein the design and planning modules are configured to set the appropriate parameters, as derived from the database, in the construction of an operation spread sheet.

15. The integrated automated management system of claim 13, wherein the design module is comprised of three components all of which have a common function of ensuring correct process sequence and limits compliance for drugs, as required by a drug regulatory authority with the first of said components comprising a process modeler adapted to define the essential process operating sequence of: key reactions, key operations and regulatory ranges and/or limits, wherein the second component comprises a plant modeler adapted to provide operation to operation step mapping, identification of viable equipment options, identification of ancillary equipment options, providing batch size scaling and providing equipment selection impact on batch data, and wherein the third component comprises an operating model adapted to provide:
i. equipment assignment,
ii. operation Step to DCS (distribution control system) phase mapping,
iii. phase parameters with review and verification,
iv. batch instruction generation and control recipe generation;
wherein the design module further comprises a simulation object model adapted to provide graph management, with said simulation object model further having means to calculate, on a detailed operation step basis, mass balance, thermodynamics, reactions, time-cycles, including critical path analysis, environmental emissions and resource contention and wherein with database “instructional” information the design module is adapted to formulate and construct an operation spread sheet.

16. The integrated automated management system of claim 12, wherein the planning module comprises means to define and/or edit control of production goals tied into a plant schedule, with an edit campaign processing order to ensure that higher priority item gets precedence in the campaign and wherein said planning module further comprises means to generate/edit prior steps campaign with multi-step defaults being implemented if necessary for said processing and/or planning wherein the prior steps campaign with multi-step defaults are linked via edit campaign properties with an alternative plant model, and wherein the planning module further comprises setup/cleaning times and prior step safety buffers to a schedule generator optimizer component for each campaign by processing order to calculate the earliest possible campaign start time, and to find the earliest time slot where a viable equipment train is available and where the planning module comprises means to effect a break of equipment candidate ties of a choice of equipment for required processes, by considering equipment cost, impact on time cycle, equipment utilization, equipment idle time and number of components.

17. The integrated automated management system of claim 12, wherein the system comprises an interface component between the design and planning modules wherein said interface component provides the planning module with detailed design data of plant selection, component scoring, candidate equipment and preferred equipment, said system further comprises a general system use-interface shell which provides an application tool framework, a navigation tree, a change distribution manager, a menu manager, a command router and a toolbar manager, the system also comprises a common services framework which includes a user comments manager, a user preference manager, provides the capability of entering electronic signatures, provides access security, authentication and details of role management, and wherein the common services framework is adapted to provide modules of the application and database with version control, an audit trail, an exception manager, with error handling and tracing, data access & caching and user help.

18. The integrated automated management system of claim 17, wherein the exploring module comprises means to oversee the production system as batch releases and provide a cross batch view, a model view, a schedule view, a material genealogy view, an instruction view and a shift view to thereby permit shift management, batch review, cross-batch analysis, with deviations, changes and general review; said exploring module further being adapted to provide process capability evaluation and performance management and optimization, wherein the exploring module, together with batch analysis, permits tighter parameters with increased yields and higher purity than batches run at the regulatory compliance levels.

19. The integrated automated management system of claim 18, wherein the exploring module and function thereof are in a closed informational loop with the design module, to thereby effect a full scale comparison between the planned operation and actual events, with feedback for correction and with provision for automated real-time scheduling changes, whereby as a result, of the constant feedback and control, regulatory authority limits, are constantly adhered to and monitored in real time, with resultant minimization or elimination of batch review.
